(19) United States
(12) Patent Application Publication
(10) Pub. No.: US 2003/0211380 A1
(43) Pub. Date: Nov. 13, 2003

(54) Solid polymer fuel cell and method of manufacturing the same

(75) Inventors: Osamu Hiroi, Tokyo (JP); Hisatoshi Fukumoto, Tokyo (JP); Yasuhiro Yoshida, Tokyo (JP); Tetsuyuki Kurata, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/429,944

(22) Filed: May 6, 2003

(30) Foreign Application Priority Data
May 10, 2002 (JP) 2002-135831
Apr. 8, 2003 (JP) 2003-104282

(51) Int. Cl. H01M 4/96; H01M 8/10; H01M 4/94

(52) U.S. Cl. 429/44; 429/30

(57) ABSTRACT

A solid polymer type fuel cell having a polyelectrolyte film having a proton conductivity; an anode electrode and a cathode electrode arranged on the opposite sides of the polyelectrolyte film; and a gas flow channel for supplying gas to the both electrodes, the anode electrode and the cathode electrode each being composed of a catalyst layer that is in contact with the polyelectrolyte film and a gas diffusion layer for allowing the diffusion of gas supplied from the gas flow channel to the catalyst layer, in which the gas diffusion layer included in the cathode electrode is constructed of a carbon-containing material and the surface of the carbon-containing material is modified to be hydrophilic.

### BACKGROUND OF THE INVENTION

1. Field of the Invention

The present invention relates to a solid polymer type fuel cell and a method of manufacturing the same. In particular, the present invention relates to a solid polymer type fuel cell capable of keeping a polyelectrolyte film in a wet state and continuously supplying gas into a catalyst layer in an efficient manner to allow an increase in the efficiency of the cell and to cut operation costs, and to a method of manufacturing the solid polymer type fuel cell.

2. Description of the Related Art

In recent years, clean power generation systems have been demanded because of growing environmental awareness, and in particular, attentions have been paid on fuel cells as one of these systems. The fuel cells include phosphoric type fuel cells, molten carbonate type fuel cells, solid electrolyte type fuel cells, solid polymer fuel cells, and so on. Among them, the solid polymer type fuel cells are being studied and developed actively as they are advantageous for their low power-generating temperatures and in terms of size reduction as compared with other types of fuel cells.

FIG. 2 is a cross sectional diagram for illustrating an example of the conventional solid polymer type fuel cell. In the figure, the solid polymer type fuel cell 21 includes a polyelectrolyte film 22 having a proton conductivity, an anode electrode 23 and a cathode electrode 24 arranged on the opposite sides of the polyelectrolyte film 22, and gas flow channels 25, 25′ for supplying gas to the both electrodes 23 and 24. The anode electrode 23 includes a catalyst layer 231 that is in contact with the polyelectrolyte film 22, and a gas diffusion layer 232 for allowing the diffusion of gas supplied from the gas flow channel 25 to the catalyst layer 231. Likewise, the cathode electrode 24 includes a catalyst layer 241 that is in contact with the polyelectrolyte film 22 and a gas diffusion layer 242 for allowing the diffusion of gas supplied from the gas flow channel 25′ to the catalyst layer 241. Here, the gas flow channels 25 and 25′ are constructed by arranging plural grooved portions in separator plates 26 and 26′, respectively.

In such a solid polymer type fuel cell 21, fuel gas (e.g., hydrogen gas) is supplied to the anode electrode 23 and an oxidizing agent (e.g., the air or oxygen gas) is supplied to the cathode electrode 24. An external circuit (not shown) connects the both electrodes to allow the fuel cell 21 to be actuated. More specifically, the anode electrode 23 receives the supply of hydrogen gas or the like from the gas flow channel 25 formed in the separator 26 at first. Then, the hydrogen gas passes through the gas diffusion layer 232 and diffuses toward the catalyst layer 231. Subsequently, the hydrogen gas having reached the catalyst layer 231 generates protons and electrons by an oxidation reaction with a catalyst. The protons pass through the solid polyelectrolyte film 22 and move to the cathode electrode 24. On the other hand, electrons pass through the external circuit (not shown) to reach the cathode electrode 24. In the cathode electrode 24, the protons having passed through the solid polyelectrolyte film 22, the electrons having been transferred from the external circuit, and oxygen gas or the like to be supplied through the gas flow channel 25′ formed in the separator plate 26′ and the gas diffusion layer 242 are reacted with each other by the catalyst layer 241 and converted into water. Concurrently, an electromotive force is generated between the electrodes, so that it becomes possible to obtain electric energies as outputs.

For effectively performing the above reaction without interruption, it is important to decrease an ion-conduction resistance and to supply gas to the catalyst layers 231 and 241 of the respective electrodes 23 and 24. For decreasing the ion-conduction resistance, the high polymer electrolyte may be always kept in a wet state with water. On the other hand, such water should be continuously drained because the contact between gas and the catalytic layer 231 (241) is prevented when the water generated in the cathode electrode 24 is retained on the surface of the catalyst layer 231 (241) or such water closes holes in the gas diffusion layer 232 (242).

For preventing the holes in the gas diffusion layer 232 (242) from being closed with water, water repellent finishing is widely performed on an electrode material using a fluorine-contained resin or the like. In particular, the gas diffusion layer 232 (242) is provided as a supply channel for allowing the gas supplied from gas flow channels 25 (25′) to reach the catalyst layer 231 (241) and is generally made water repellent. However, even though the water repellent finishing avoids the retention of water in the gas diffusion layer 232 (242), the water is retained on the surface of the catalyst layer 232 (242) as the transfer of water on the surface of the catalyst layer 232 (242) to the gas diffusion layer 232 (242) is prevented. Therefore, it becomes difficult to continuously supply the gas to the catalyst layer 232 (242).

In the solid polymer type fuel cell, as described above, the more the polyelectrolyte film contains water, the more the ion-conduction resistance decreases to improve the performance of the fuel cell. For this reason, the gas is supplied after being heated by an external humidifier in advance to keep the polyelectrolyte film in a wet state. When a liquid (i.e., water) is vaporized for humidifying the gas, latent heat of vaporization can be consumed as energies. Therefore, the more the degree of humidification is increased for increasing the performance of the fuel cell, the more the consumption energy increases. In addition, there is another problem in that an increase in heat loss is caused due to the heat dissipation from the body of a humidifier or heat dissipation through a gas pipe arrangement from the humidifier to the fuel cell.

For solving those problems drastically, there is a need to operate the fuel cell at a smaller amount of gas humidification. However, when a solid polymer type fuel having a general configuration is operated at a low humidification area, the performance of the fuel cell is significantly reduced as the water content of the electrolytic film decreases. For operating the fuel cell in a low humidification area, there is a need of designing the fuel cell so as to keep the electrolytic film in a wet state. As such a method, the following techniques have been known in the art.

JP 7-326361 A discloses an electrode in which a water-absorbing resin or a water-absorbing inorganic substance is dispersed and mixed in a gas diffusion layer. In this prior art, however, the water-absorbing substance is impregnated and dispersed in holes of the gas dispersion layer. Therefore, there is a disadvantage in that the gas-diffusing ability of the gas dispersion layer is reduced as the void content thereof decreases. When a water-absorbing resin is used, in particular, the resin is swollen with water so that the void content is reduced. In addition, an organic water-absorbing substance cannot be stable for a long time under severe high-temperature and high-humidity conditions in the fuel cell.

In addition, JP 11-45733 A discloses a solid polymer in which hydrophilic inorganic fine particles such as silica or alumina are coated on the gas diffusion layer together with carbon particles and a hydrophilic layer is provided between a catalyst layer and the gas diffusion layer. However, in this prior art, water is retained on the surface of the catalyst layer as the hydrophilic inorganic fine particles are arranged in the neighborhood of the catalyst layer, even though a polyelectrolyte film is prevented from being dried. Therefore, there is a problem in that the continuous supply of gas to the catalyst layer is difficult. Furthermore, the void content of the gas diffusion layer decreases as the usage amount of the hydrophilic inorganic fine particles increases. Therefore, a decrease in the gas-supplying ability may occur. Furthermore, as the hydrophilic layer has a small thickness, only a small humidification effect can be attained by the vaporization of water being stored in this layer. Furthermore, the invention of JP 11-45733 A is characterized in that a thin layer of a hydrophilic substance is provided between a catalyst layer and a dispersion layer. However, the space where gas passes through is closed easily when water is accumulated in the thin hydrophilic layer. Therefore, the so-called flooding phenomenon becomes significant, resulting in a decrease in the performance of the fuel cell.

Furthermore, the technique disclosed in JP 6-275282 A has been known for keeping an electrolytic film in a wet state by the application of a hydrophilic material in the inside of the catalyst layer. However, as the catalyst layer is substantially thinner than the dispersion layer, the amount of water being accumulated in the catalyst layer is small. In addition, water is accumulated on the surface of the catalyst layer when the catalyst layer itself is hydrophilic. Therefore, the contact between the catalyst and the gas become more difficult as the water covers the surface of the catalytic layer. Such a state also represents the so-called flooding phenomenon so that the performance of the fuel cell decreases to a large extent.

In the case of operating the fuel cell under low-humidification conditions, a portion on the upstream of a gas flow in the cathode surface of the solid polymer type fuel cell tends to be dried with low-humidified gas, while a portion on the downstream of the gas flow tends to be humidified with reaction-product water. Therefore, there is a problem in that, due to such water distribution, it is impossible to utilize the surface of the cathode in a uniform manner, resulting in a decrease in the performance of the fuel cell.

### SUMMARY OF THE INVENTION

Therefore, an object of the present invention is to provide a solid polymer type fuel cell capable of keeping a polyelectrolyte film in a wet state and continuously supplying gas into a catalyst layer in an efficient manner to allow an increase in the efficiency of the cell and to cut operation costs, and also to provide a method of manufacturing the solid polymer type fuel cell.

The present invention is directed to a solid polymer type fuel cell including: a proton-conductive polyelectrolyte film; an anode electrode and a cathode electrode arranged on the opposite sides of the polyelectrolyte film; and a gas flow channel for supplying gas to the anode electrode and the cathode electrode, the anode electrode and the cathode electrode each being composed of a catalyst layer that is in contact with the polyelectrolyte film and a gas diffusion layer for diffusing the gas supplied from the gas flow channel to the catalyst layer, characterized in that the gas diffusion layer included in the cathode electrode is constructed of a carbon-containing material and the surface of the carbon-containing material is modified to be hydrophilic.

Furthermore, the invention is directed to a method of manufacturing a solid polymer type fuel. The method includes forming an anode electrode and a cathode electrode on the both sides of a proton-conductive polyelectrolyte film and forming gas flow channels on the outsides of the anode electrode and the cathode electrode, characterized in that the surface of the carbon-containing material is modified to be hydrophilic and is then used as a gas diffusion layer included in the cathode electrode.

According to the above constitution, the polyelectrolyte film can be kept in a wet state while continuously supplying gas to the catalyst layer in an efficient manner, so that it becomes possible to provide a solid polymer type fuel cell allowing an increase in cell efficiency while preventing an increase in operation costs.

### BRIEF DESCRIPTION OF THE DRAWINGS

In the accompanying drawings:

FIG. 1 is a cross sectional view for illustrating an example of a solid polymer type fuel cell in accordance with the present invention;

FIG. 2 is a cross sectional view for illustrating an example of a solid polymer type fuel cell; and

FIG. 3 is a graph that shows an output voltage with respect to a cathode gas dew-point in each of fuel cells obtained in Examples 1 to 6.

### DETAILED DESCRPITION OF THE INVENTION

Hereinafter, the present invention will be described in more detail with reference to the attached drawings.

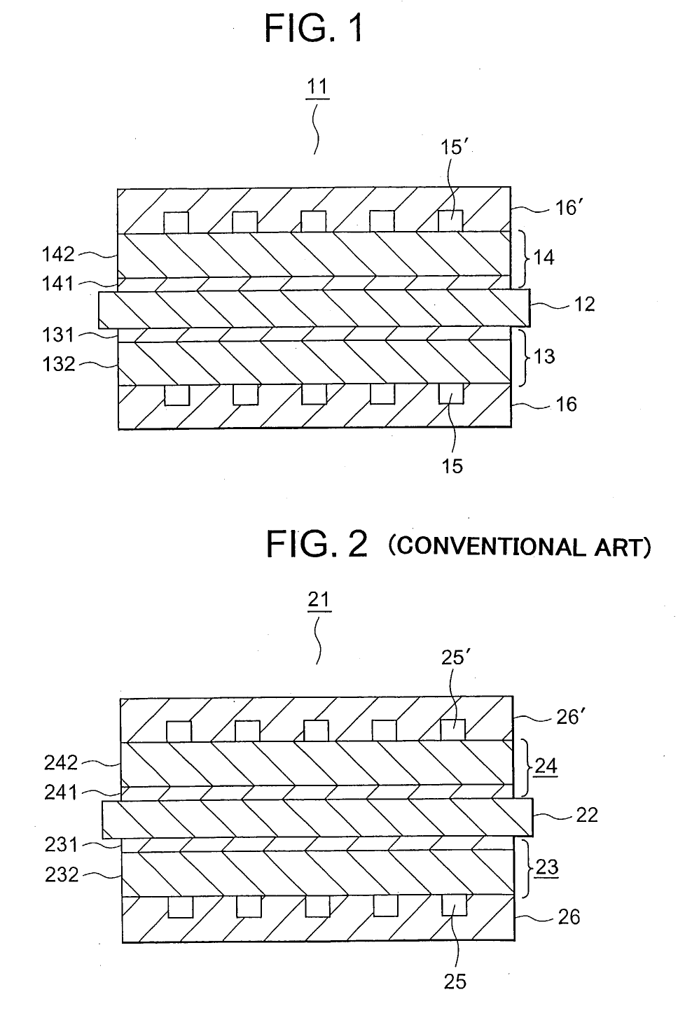

Referring now to FIG. 1, there is shown a cross sectional view for illustrating an example of a solid polymer type fuel cell according to the present invention.

In FIG. 1, a solid polymer type fuel cell 11 includes a proton-conductive polyelectrolyte film 12, an anode electrode 13 and a cathode electrode 14 arranged on the opposite sides of the polyelectrolyte film 12, and gas flow channels 15 and 15′ for supplying gas to the both electrodes 13 and 14. The anode electrode 13 includes a catalyst layer 131 that is in contact with the polyelectrolyte film 12, and a gas diffusion layer 132 for allowing the diffusion of gas supplied from the gas flow channel 15 to the catalyst layer 131. Likewise, the cathode electrode 14 includes a catalyst layer 141 that is in contact with the polyelectrolyte film 12 and a gas, diffusion layer 142 for allowing the diffusion of gas supplied from the gas flow channel 15′ to the catalyst layer 141. Here, the gas flow channels 15 and 15′ are constructed by arranging plural grooved portions in separator plates 16 and 16′, respectively. The configuration of the above-described fuel cell itself-is similar to that of the conventional one. However, the present invention is characterized in that the gas diffusion layer 142 included in the cathode electrode 14 is constructed of a carbon-containing material and the surface of the carbon-containing material is modified to be hydrophilic.

The polyelectrolyte film 12 is preferably a polyelectrolyte film having high proton conductivity and high gas-barrier property without any electron conductivity, which is stable under environmental conditions inside the fuel cell. In general, a polyelectrolyte film having a perfluoro main chain with a sulfonic group may be used.

The catalyst layer 131 included in the anode electrode 13 may be, for example, an alloy of platinum and a noble metal (e.g., ruthenium, rhodium, or iridium), an alloy of platinum and a base metal (e.g., vanadium, chromium, cobalt, or nickel), or the like supported on carbon fine particles or the like.

The catalyst layer 141 included in the cathode electrode 14 maybe, for example, platinum supported on carbon black fine particles, platinum black, or the like.

As described above, the present invention is characterized in that the gas diffusion layer 142 included in the cathode electrode 14 is constructed of a carbon-containing material and the surface of the carbon-containing material is modified to be hydrophilic. The catalyst layer 141 is in contact with the gas diffusion layer 142, so that water on the surface of the catalyst layer 141 moves quickly toward the gas diffusion layer 142 having a high hydrophilic property. Consequently, it is possible to solve the conventional problem in which the continuous supply of gas to the catalyst layer becomes difficult as water is retained on the surface of the catalyst layer. Furthermore, the carbon-containing material to be used is preferably made of carbon fibers. In particular, a porous material made of carbon fibers such as carbon paper, carbon cloth, or carbon non-woven fabric. In addition, the diameter of the carbon fiber is preferably in the range of 5 to 20 μm, for example. Here, the term “hydrophilic property” used in the present invention is represented by a contact angle of 0 to 10° with respect to the surface of the solid.

The surface of a carbon-containing material, especially carbon fibers is preferably covered with a hydrophilic material having a thickness of 50 nm to 1 μm. In addition, when the material is comprised of carbon fibers with a diameter of 10 μm, the amount of the carbon fibers to be covered is preferably 2 to 15% by weight with respect to the weight of the carbon-containing material. Here, the term “the surface of carbon fibers” means the whole surface of the carbon fibers including the inner surface of a porous material comprised of the carbon fibers.

In the case of using the carbon fibers covered with a hydrophilic material, water that has moved to the gas diffusion layer 142 spreads so as to cover the surface of each carbon fiber having a continuous layer that is modified to be hydrophilic. Consequently, the water surface area of the inside of the gas diffusion layer 142 becomes extremely large, so that the vapor rate thereof is increased. Furthermore, the movement of water from a water-excess portion to a dry portion is accelerated. The gas fed from gas flow channels 15′ is humidified sufficiently by the resulting water vapor in the course of reaching the catalyst layer 141. As a result, even if the gas under low-humidification conditions is supplied to the fuel cell, the same performance as that of the prior art can be maintained. Therefore, the energies consumed by an external humidifier become smaller as compared with the prior art. In addition, it becomes possible to lower the temperature of pipe arrangement that supplies gas from the external humidifier to the fuel cell, as compared with the prior art. Therefore, the energy loss by heat dissipation decreases. In addition, by operating the fuel cell under further low-humidification conditions, the so-called flooding phenomenon, which is a phenomenon in which the performance is reduced due to retention of water in the electrode, becomes less liable to occur.

The low-humidification driving condition described here indicates an area in which the dew point of the supplied gas is about 10° C. or more lower than the temperature of the main body of the fuel cell when the temperature of the main body of the fuel cell is 75 to 80° C., an area in which the dew point of the supplied gas is almost 15° C. or more lower than the temperature of the main body of the fuel cell when the temperature of the main body of the fuel cell is 70 to 75° C., or an area in which the dew point of the supplied gas is about 20° C. or more lower than the temperature of the main body of the fuel cell when the temperature of the main body of the fuel cell is 60 to 70° C.

In the present invention, the space through which gas passes easily is not closed by water because the whole of the dispersion layer, which occupies the largest space volume in the inside of the solid polymer type fuel cell, is utilized. As described below, the flooding may occur when the fuel cell is operated for a long time in a high humidification area. However, the flooding does not occur in the low humidification area.

In addition, the whole surface of the carbon-containing material provided as a material of the gas diffusion layer is made hydrophilic, so that the surface area of water in the dispersion layer becomes extremely large. Therefore, a vapor rate is high so that, when the gas under low-humidification conditions passes through the dispersion layer, the gas can be efficiently humidified. Consequently, it becomes possible to prevent a decrease in content of the electrolytic film.

Furthermore, the hydrophilic layer on the surface of the gas diffusion layer continuously extends over the whole surface of the dispersion layer, so that water is able to move easily from a water-excess portion to a water-deficient portion in the surface. Therefore, a decrease in ion conductivity which occurs due to the flooding resulting from a water excess or due to a water deficiency is overcome so that the whole surface can be efficiently utilized. Therefore, the output of the fuel cell can be increased.

The method for modifying the surface of the carbon-containing material to be hydrophilic is not particularly limited. Various kinds of methods well-known in the art can be applied.

There is known a method for forming hydrophilic groups on the surface of a carbon-containing material by performing plasma, corona, and anodizing treatments thereon. In such a method, however, when a porous material is used as such a carbon-containing material, it is difficult to make the inside thereof be rendered sufficiently hydrophilic and to keep the hydrophilic property of the resulting product for a long period of time.

For avoiding such disadvantages, the present inventors have made extensive studies and found a material and a method which allow the inside of the material to be imparted with sufficient hydrophilic property and allow the hydrophilic property to be kept for a long period of time even in the case of using a porous material.

That is, the above-mentioned material may be a metal oxide, and in particular, titanium oxide (TiO₂), aluminum oxide (Al₂O₃), and silicon dioxide (SiO₂) are preferable.

The above-mentioned method may be a CVD method for obtaining a thin film from a gas phase, a sol-gel method for obtaining a metal oxide by hydrolyzing metal alkoxide, a method for thermally decomposing an organic metal complex, or the like. Among them, the so-called liquid phase deposition (LPD) method for precipitating an oxide thin film from a metal fluoride aqueous solution is preferable. More specifically, the carbon-containing material (e.g., carbon fibers) is dipped into a metal fluoride-containing aqueous solution. Then, the surface of carbon fibers is coated with a metal oxide which is precipitated from the metal fluoride-containing aqueous solution.

The liquid phase deposition is particularly advantageous in that a large-sized material of the gas diffusion layer can be treated in large quantity, it is possible to make a uniform coating on the material even though a porous material having a complicated shape and comprised of carbon fibers is used, and that the treatment costs or the like are low. In addition, as the coating can be performed at a temperature near a normal temperature, only a small amount of the treatment energy is required.

The above sol-gel process includes immersing the material of the gas diffusion layer into a solution that contains metal-alkoxide, drying the layer, and baking it at about 500° C. This method also forms a coating of metal oxide. The sol-gel process is capable of obtaining a high-purity metal oxide film such as SiO₂, Al₂O₃, or TIO₂.

In addition, the thickness of the coating of a hydrophilic material is preferably small for preventing a decrease in the volume of holes of the gas diffusion film 142 and also for the reason that a thin coating does not easily exfoliate. However, the effects of modification on hydrophilic properties may not be easily expressed due to a coating defect of the coating is too thin.

If the hydrophilic material to be applied is a metal oxide, there is a possibility of an increase in resistance as the material is a nonconductive material. In this case, it is effective to form a conductive portion on a place obtained by slightly grinding the materials that constitute the gas diffusion layer 142 and the catalyst layer 141, and/or the material that forms the gas flow channels, i.e., by slightly grinding a contact portion with the separator plate.

The solid polymer type fuel cell 11 of the present invention can be prepared by forming the anode electrode 13 and the cathode electrode 14 on the opposite sides of the polyelectrolyte film 12. Here, the anode electrode 13 includes the catalyst layer 131 and the gas diffusion layer 132 and the cathode electrode 14 includes the catalyst layer 141 and the gas diffusion layer 142. Furthermore, on the outside of the both electrodes 13 and 14, the gas flow channels 15 and 15′ are formed, respectively. In addition, the catalyst layers 131 and 141 may be prepared by a method in which they are formed on a polyelectrolyte film 12, a method of forming them on one side of each of the gas distribution layers 132 and 142, and a method of forming them as independent layers.

Here, a carbon plate is generally used for each of the separator plates 16 and 16′.

A fuel cell constructed as described is incorporated in a battery jig in the same manner as in the prior art. The generation of electricity is performed by supplying humidified hydrogen or the like into the anode electrode, while supplying oxidizer gas including humidified air into the cathode electrode.

### EXAMPLES

Hereinafter, the present invention will be described in more detail with the following examples and comparative examples.

### Example 1

(Hydrophilic Modification Treatment on the Surface of a Carbon-Containing Material)

Carbon paper (TGP-H-090, manufactured by Toray Industries. Inc.) was dipped into an aqueous solution that contains 0.1 moles/1 of ammonium titanium hexafluoride and 0.2 moles/1 of boric acid. After defoaming, the solution was kept at 30° C. for 20 hours to make the carbon paper a gas diffusion layer. The carbon paper after the treatment was covered with a thin film of titanium oxide, so that the carbon paper presented a color interfered with the thin film of titanium oxide. From the difference between the weights of carbon paper before and after the treatment, it was found that 1.5 mg of titanium oxide per cm³ of carbon paper was coated. The volume of the coating of titanium oxide was about 0.38×10⁻³ cm³ equivalent to the specific gravity of the coating, so that the volume of hole in the carbon paper was hardly reduced. Therefore, the coating treatment does not directly prevent-the gas diffusion.

Next, the carbon paper before the treatment and the carbon paper after the treatment were dipped into pure water for 10 seconds, followed by comparing their respective water absorption amounts by a gravimetric method. After the treatment, the carbon paper after the treatment retains about 10 times of water per unit area, as compared with the carbon paper before the treatment. Therefore, it was found that the hydrophilic property of the carbon paper was significantly increased by the coating. The coated carbon paper was slightly ground using a waterproof abrasive paper (#2000) to remove a part of the covering layer on the surface to be in contact with the separator plate and the catalyst layer.

(The Formation of Catalyst Layer)

The catalyst used in this example was a catalytic metal supported on the carbon black (acetylene black). A cathode catalyst was one supporting 50% by weight of platinum and an anode catalyst was one supporting 50% by weight platinum-ruthenium metal.

In 1 part by weight of catalyst powders, 5 parts by weight of a perfluoro-polyelectrolyte (9 parts by weight) solution (FSS-1, manufactured by Asahi Glass Co., Ltd.) and 1 parts by weight of water were added, followed by mixing with stirring to obtain uniform paste. Then, the catalyst paste was screen-printed on a 25-μm PET (polyethylene terephthalate) film and then dried. Then, a polyelectrolyte film (50 μm in thickness, Aciplex film manufactured by Asahi Kasei Co., Ltd.) was sandwiched between the films having the above catalytic layer and was then subjected to a hot press at 150° C. for 2 minutes to remove the PET film to thereby form a catalyst layer on the polyelectrolyte film. The catalyst layer was formed into a square shape of 50 mm×50 mm.

(The Formation of Cell}

A polyelectrolyte film having the catalyst layer described above is sandwiched between the gas diffusion layers. Furthermore, they were sandwiched between carbon plates having gas flow grooves to provide a solid polymer type fuel cell as shown in FIG. 1. As gas diffusion layers, carbon paper treated with the hydrophilic modification was used on the cathode electrode side, while carbon paper without hydrophilic modification treatment was placed on the anode electrode side.

(Operation of Cell)

The fuel cell received the supply of hydrogen gas on its anode electrode side and the supply of the air at a normal pressure on the cathode electrode side. In addition, their flows were adjusted such that the utilization of hydrogen gas was 70% and the utilization of oxygen on the air side was 40%. The gas was supplied to the cell after humidifying with an external humidifier. In addition, the temperature of the cell was adjusted to 80° C. Regarding the humidity of the supply gas, the external humidifier was adjusted such that the anode side was a dew point of 65° C. and the cathode side was a predetermined dew point. Then, the cell was operated at a current density of 300 mA/cm² and an output voltage at 24 hours after the initiation was measured. The changes of voltages and resistances of the fuel cell with respect to the humidifying temperature were shown in Table 1.

### Comparative Example 1

A fuel cell was prepared and operated in the same manner as in Example 1, except that carbon paper without hydrophilic modification treatment was used for the gas diffusion layer on the cathode electrode side. The changes of voltages and resistances of the fuel cell with respect to the humidifying temperature were shown in Table 1.

### Comparative Example 2

A fuel cell was prepared and operated in the same manner as in Example 1, except of the hydrophilic modification treatment to be performed by the following steps.

(Hydrophilic Modification Treatment)

In 1 part by weight of titanium oxide powders in average particle size of 0.5 μm, 3 parts by weight of a perfluoro-polyelectrolyte (9 parts by weight) solution (FSS-1, manufactured by Asahi Glass Co., Ltd.) and 3 parts by weight of water were added, followed by mixing with stirring to obtain uniform paste. Then, the paste was dried after screen printing on one side of the carbon black. Subsequently, the carbon paper before the treatment and the carbon paper after the treatment were dipped into pure water for 10 seconds, followed by comparing their respective water absorption amounts by a gravimetric method. After the treatment, the carbon paper after the treatment retains about 3 times of water per unit area, compared with the carbon paper before the treatment. Therefore, it was found that the hydrophilic property of the carbon paper was significantly increased by the coating of titanium oxide particles. The resulting hydrophilic layer was arranged so as to be in contact with the catalytic layer.

### Example 2

A fuel cell was prepared and operated in the same manner as in Example 1, except that the treatment was performed for 5 hours. It was found that a coating amount of 0.2 mg per cm³ of the carbon paper was obtained from the difference between the weights of the carbon paper before and after the treatment.

When a comparison was made between the water absorption amount of the carbon paper before the treatment and that after the treatment in the same manner as in Embodiment 1, the carbon paper after the treatment retained about 3 times of water per unit area as compared with the carbon paper before the treatment.

The changes of voltages and resistances of the fuel cell with respect to the humidifying temperature were shown in Table 1.

### Example 3

A fuel cell was prepared and operated in the same manner as in Example 1, except that the treatment was performed for 40 hours. It was found that a coating amount of 2.5 mg per cm³ of the carbon paper was obtained from the difference between the weights of the carbon paper before and after the treatment.

When a comparison was made between the water absorption amount of the carbon paper before the treatment and that after the treatment in the same manner as in Embodiment 1, the carbon paper after the treatment retained about 10 times of water per unit area as compared with the carbon paper before the treatment.

The changes of voltages and resistances of the fuel cell with respect to the humidifying temperature were shown in Table 1.

### Example 4

A fuel cell was prepared and operated in the same manner as in Example 1, except that the hydrophilic modification treatment is performed by the following steps.

The changes of voltages and resistances of the fuel cell with respect to the humidifying temperature were shown in Table 1. Further, the resistances of the fuel cell with respect to the humidifying temperature were shown in Table 1.

The changes of voltages and resistances of the fuel cell with respect to the humidifying temperature were shown in Table 1.

(Hydrophilic Modification Treatment)

Silica gel was dissolved as much as possible in a hydrosiliconfluoric acid 2 mol/1 solution. An aqueous solution was obtained by dissolving boric acid in this solution to have a concentration of 0.024 mol/1. The carbon paper was dipped in the aqueous solution, which was then held at 30° C. for 20 hours to coat the carbon paper with a silica thin film.

It was found that the carbon paper was coated with 0.9 mg/cm³ of silica. Next, the carbon paper before the treatment and the carbon paper after the treatment were dipped into pure water for 10 seconds, followed by comparing their respective water absorption amounts by a gravimetric method. After the treatment, the carbon paper after the treatment retains about 8 times of water per unit area, as compared with the carbon paper before the treatment. Therefore, it was found that the hydrophilic property of the carbon paper was significantly increased by the coating. The coated carbon paper was slightly ground using a waterproof abrasive paper (#2000) to remove a part of the covering layer on the surface to be in contact with the separator plate and the catalyst layer.

The changes of voltages and resistances of the fuel cell with respect to the humidifying temperature were shown in Table 1.

### Example 5

A fuel cell was prepared and operated in the same manner as in Example 1, except that the hydrophilic modification treatment is performed by the following steps.

The changes of voltages and resistances of the fuel cell with respect to the humidifying temperature were shown in Table 1.

(Hydrophilic Modification Treatment)

Carbon paper was dipped into a solution prepared by adding 0.5 parts by weight of diethanol amine and 50 parts by weight of isopropanol into 1 part by weight of titanium tetraisopropoxide and was then pulled out of the solution, followed by drying at 100° C. for 10 minutes. Subsequently, the carbon paper was subjected to heating at 300° C. for 1 hour to remove organic components to coat a thin film of titanium oxide. At the time of heating treatment, a part of the titanium oxide thin film was peeled and dropped off. It was found that the carbon paper was coated with 3 mg/cm³ of titanium oxide. Next, the carbon paper before the treatment and the carbon paper after the treatment were dipped into pure water for 10 seconds, followed by comparing their respective water absorption amounts. After the treatment, the carbon paper after the treatment retains about 6 times of water per unit area, compared with the carbon paper before the treatment. Therefore, it was found that the hydrophilic property of the carbon paper was significantly increased by the coating. The coated carbon paper was slightly ground using a waterproof abrasive paper (#2000) to remove a part of the covering layer on the surface to be in contact with the separator plate and the catalyst layer.

### Example 6

(Hydrophilic Modification Treatment on the Surface of a Carbon-Containing Material)

The hydrophilic modification treatment was performed in the same manner as in Example 1. (The Formation of Catalyst Layer)

The catalyst used in this example was a catalytic metal supported on the carbon black. A cathode catalyst was one supporting 50% by weight of platinum and an anode catalyst was one supporting 50% by weight of platinum-ruthenium metal.

In 1 part by weight of cathode catalyst powders, 5 parts by weight of a perfluoro-polyelectrolyte (9 parts by weight) solution (FSS-1, manufactured by Asahi Glass Co., Ltd.) and 1 parts by weight of water were added, followed by mixing with stirring to obtain uniform paste for the cathode.

In 1 part by weight of anode catalyst powders, 7 parts by weight of a perfluoro-polyelectrolyte (9 parts by weight) solution (FSS-1, manufactured by Asahi Glass Co., Ltd.) and 1 parts by weight of water were added, followed by mixing with stirring to obtain uniform paste for the anode. Then, those catalyst pastes were screen-printed on a 25-μm PET film and then dried to obtain a transcription catalyst layer. Then, a polyelectrolyte film (50 μm in thickness, Aciplex film manufactured by Asahi Kasei Co., Ltd.) was sandwiched between the films having the above catalytic layer and was then subjected to a hot press at 150° C. for 2 minutes to transfer the catalyst layer on to the polyelectrolyte film. The catalyst layer was formed into a square shape of 50 mm×50 mm.

(Formation of Cell}

The cell was prepared in the same manner as in Example 1.

(Operation of Cell)

The fuel cell received the supply of hydrogen gas on its anode side and the supply of the air at a normal pressure on the cathode side. In addition, their flows were adjusted such that the utilization of hydrogen gas was 80% and the utilization of oxygen on the air side was 50%. The gas was supplied to the cell after humidifying with an external humidifier. In addition, the temperature of the cell was adjusted to 75° C. Regarding the humidity of the supply gas, the external humidifier was adjusted such that the anode side was a dew point of 65° C. and the cathode side was a predetermined dew point. Then, the cell was operated at a current density of 250 mA/cm² and an output voltage at 24 hours after the initiation was measured. The changes of voltages and resistances of the fuel cell with respect to the humidifying temperature were shown in Table 1.

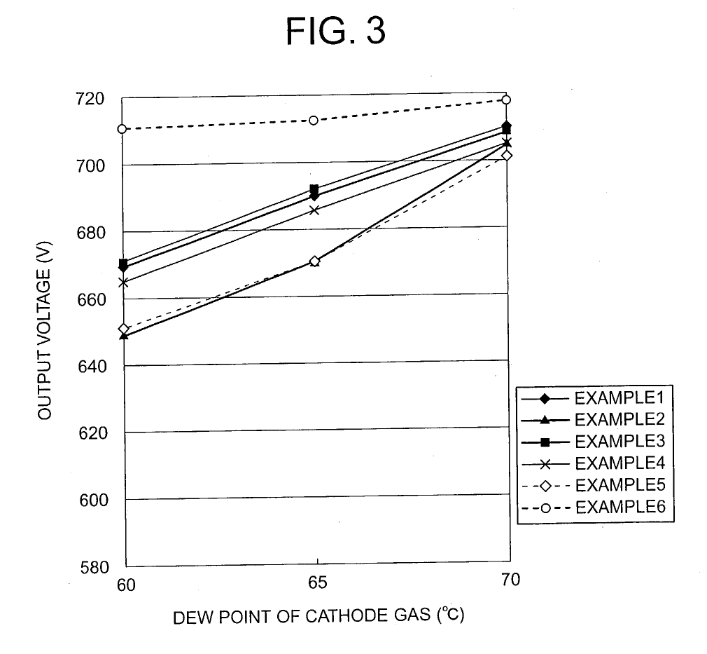

Furthermore, in FIG. 3, the output voltages for the dew point of the cathode gas in each fuel cell obtained in Examples 1 to 6 were shown.

| | Voltage (mV) | | | Resistance (m.) | | |
|---|---|---|---|---|---|---|
| | Dew point of cathode gas | | | | | |
| Example | 60° C. | 65° C. | 70° C. | 60° C. | 65° C. | 70° C. |
| Example 1 | 678 | 697 | 710 | 5.8 | 5.1 | 4.3 |
| Example 2 | 661 | 670 | 705 | 6.1 | 5.3 | 4.5 |
| Example 3 | 679 | 695 | 708 | 5.8 | 5.0 | 4.3 |
| Example 4 | 665 | 686 | 705 | 6.0 | 5.4 | 4.5 |
| Example 5 | 651 | 670 | 701 | 6.1 | 5.3 | 4.6 |
| Example 6 | 711 | 712 | 717 | 6.2 | 5.16 | 4.1 |
| Comparative | 605 | 655 | 705 | 8.0 | 6.6 | 5.0 |
| Example 1 | | | | | | |
| Comparative | 631 | 661 | 694 | 6.5 | 5.7 | 4.6 |
| Example 2 | | | | | | |

Table 1 shows that the fuel cell of Example 1 has a resistance smaller than that of the fuel cell of Comparative Example 2. Particularly, in a lower humidification area where the dew point of air is 65° C. or less, the resistance is dramatically decreased as a result of the effect for modifying the surface of the gas diffusion layer to be hydrophilic. Therefore, according to the present invention, the gas diffusion layer has a humidifying effect to improve the performance of the fuel cell with a decrease in the resistance of the polyelectrolyte film. Such an effect becomes significant in the low humidification area. From Table 1, it is found that the fuel cell of Example 1 has a higher voltage and higher performance than the fuel cell of the Comparative Example 1 or Example 2 as the surface of the material that constitutes the gas diffusion layer is coated with a metal oxide having a high hydrophilic property. Particularly, in the low humidifying area where the dew point of the air which is gas to be supplied to the cathode electrode is 65° C. or less, an excellent effect of modifying the hydrophilicity can be found, contributing the improvement of the performance of the fuel cell.

As is evident from Table 1, the fuel cell of Example 2 has a shorter hydrophilic modification treatment time of the diffusion layer, as compared with Example 1. Therefore, the surface of the carbon paper is not sufficiently covered with a hydrophilic film. Therefore, it can be considered that the performance improving effect is small in the low humidifying area.

As is evident from Table 1, the fuel cell of Example 3 has a longer hydrophilic treatment time and a large amount of the coating in comparison with those of Example 1, while the amount of water absorbed in the carbon paper and the performance of the fuel cell are equal to those of Example 1. In other words, even though the thickness of the coating is higher than that of Example 1, the effect of improving the performance of the fuel cell is not changed.

As is evident from Table 1, the gas diffusion layer can be modified to be hydrophilic while the same effect can be obtained even though silica is used as metal oxide as described in Example 4.

As is evident from Table 1, just as in the case of Example 5, the adaptation of sol-gel method also allows the hydrophilic modification of the gas diffusion layer and the same effect can be obtained.

As is evident from Table 1, the fuel cell of Example 6 is designed such that the configuration of the catalyst layer and the operational conditions of Example 1 are modified. Example 6 shows an output voltage under low-humidification operational conditions, which is higher than that of Example 1.

What is claimed is:

1. A solid polymer type fuel cell comprising: a proton-conductive polyelectrolyte film; an anode electrode and a cathode electrode arranged on the opposite sides of the polyelectrolyte film; and a gas flow channel for supplying gas to the anode electrode and the cathode electrode, the anode electrode and the cathode electrode each including a catalyst layer that is in contact with the polyelectrolyte film and a gas diffusion layer for diffusing the gas supplied from the gas flow channel to the catalyst layer, wherein the gas diffusion layer included in the cathode electrode is constructed of a carbon-containing material and the surface of the carbon-containing material is modified to be hydrophilic.

2. A solid polymer type fuel cell according to claim 1, wherein the carbon-containing material is made of carbon fibers.

3. A solid polymer type fuel cell according to claim 2, wherein the surface of the carbon fibers is coated with a hydrophilic material.

4. A solid polymer type fuel cell according to claim 3, wherein the hydrophilic material is constructed of metal oxide.

5. A solid polymer type fuel cell according to claim 3, wherein the coating of the hydrophilic material on the surface of the carbon fibers is removed from a contact portion between the coating portion and a material that constitutes the catalyst layer and/or a material that constitutes the gas flow channel.

6. A method of manufacturing a solid polymer type fuel according to claim 1, comprising forming an anode electrode and a cathode electrode on the both sides of a proton-conductive polyelectrolyte film and forming gas flow channels on the outsides of the anode electrode and the cathode electrode, wherein the surface of the carbon-containing material is modified to be hydrophilic and is then used as a gas diffusion layer included in the cathode electrode.

7. A method of manufacturing a solid polymer type fuel cell according to claim 6, wherein the carbon-containing material is made of carbon fibers and the surface of the carbon fibers is coated with metal oxide precipitated from an aqueous solution that contains metal fluoride by dipping the carbon fibers in the aqueous solution that contains metal fluoride.
